(19) United States
(12) Patent Application Publication
(10) Pub. No.: US 2022/0070179 A1
(43) Pub. Date: Mar. 3, 2022

(54) DYNAMIC SEGMENTATION APPARATUS AND METHOD FOR PREVENTING SPREAD OF SECURITY THREAT

(71) Applicant: ELECTRONICS AND TELECOMMUNICATIONS RESEARCH INSTITUTE, Daejeon (KR)

(72) Inventors: Seon-Gyoung SOHN, Daejeon (KE); Kyeong-Tae KIM, Daejeon (KR); Young-Ho KIM, Daejeon (KR); Jeong-Nyeo KIM, Daejeon (KR); Yun-Kyung LEE, Daejeon (KR); Jae-Deok LIM, Sejong-si (KR)

(73) Assignee: ELECTRONICS AND TELECOMMUNICATIONS RESEARCH INSTITUTE, Daejeon (KR)

(21) Appl. No.: 17/331,156

(22) Filed: May 26, 2021

(30) Foreign Application Priority Data
Sep. 3, 2020 (KR) 10-2020-0112265

(51) Int. Cl. H04L 29/06

(52) U.S. Cl. CPC H04L 63/145; H04L 63/1433; H04L 63/1425; H04L 63/1416

(57) ABSTRACT

Disclosed herein are a dynamic segmentation apparatus and method for preventing a spread of a security threat. The dynamic segmentation apparatus includes one or more processors and execution memory for storing at least one program executed by the processors, wherein the program is configured to register feature information of a first device, which is a target for which a security threat is to be managed, generate a first segment from the feature information of the first device, receive security threat information from an external system, extract feature information of a second device, in which a security threat has occurred, from the security threat information, perform clustering on the feature information of the second device using at least one clustering algorithm, generate at least one segment set by identifying segments from clustering results, and determine a security threat segment based on an inclusion relationship between segments in the segment set.

### CROSS REFERENCE TO RELATED APPLICATION

This application claims the benefit of Korean Patent Application No. 10-2020-0112265, filed Sep. 3, 2020, which is hereby incorporated by reference in its entirety into this application.

### BACKGROUND OF THE INVENTION

### 1. Technical Field

The present invention relates generally to technology for preventing the spread of security threats in the Internet of Things (IoT), and more particularly to dynamic segmentation technology for an IoT device for preventing the spread of security threats.

### 2. Description of the Related Art

Security threats in an Internet of Things (IoT) environment are achieved by stealing the authority to an IoT device by taking advantage of vulnerabilities of the IoT device and forming a large-scale botnet so as to launch a Distributed Denial of Service (DDoS) attack. Further, IoT devices infected with malicious code may be occasionally abused in threats such as cryptocurrency miners (coinminer) or the leakage of private information.

Most IoT devices are not equipped with a security function due to the low-specification and low-power characteristics thereof, and are thus vulnerable to cyber attacks. Further, because the number of IoT devices has greatly increased, attackers can easily abuse IoT devices as a means of attack.

Therefore, there is required technology for minimizing damage to IoT service by preventing the spread of security threats penetrating an IoT infrastructure from spreading throughout the entire IoT infrastructure.

Meanwhile, Korean Patent No. 10-2020488 entitled “Apparatus for Internet access control of IoT devices and method therefor” discloses an apparatus and method for allowing more flexible access control by simplifying configuration using only IoT devices and a policy file server and by setting a policy file for each IoT device or setting a policy file for each group.

### SUMMARY OF THE INVENTION

Accordingly, the present invention has been made keeping in mind the above problems occurring in the prior art, and an object of the present invention is to prevent the spread of a security threat penetrating an IoT infrastructure from spreading throughout the entire IoT infrastructure.

Another object of the present invention is to minimize the spread of a security threat by identifying a device having a strong possibility of occurrence of a security threat and isolating the corresponding device.

In accordance with an aspect of the present invention to accomplish the above objects, there is provided a dynamic segmentation apparatus for preventing a spread of a security threat, including one or more processors, and an execution memory for storing at least one program that is executed by the one or more processors, wherein the at least one program is configured to register feature information of a first device, which is a target for which a security threat is to be managed, generate a first segment from the feature information of the first device, receive security threat information from an external security detection system, and extract feature information of a second device, in which a security threat has occurred, from the security threat information, to perform clustering on the feature information of the second device using at least one preset clustering algorithm and generate at least one segment set by identifying segments from results of performing the clustering, and to determine a security threat segment based on an inclusion relationship between segments included in the at least one segment set.

The at least one program may be configured to extract a feature factor to be used for clustering from the feature information of the second device and perform data preprocessing on the feature factor.

The at least one program may be configured to perform data preprocessing of converting a character string value of the feature factor into a numeric value.

The at least one program may be configured to generate one or more clusters using at least one preset clustering algorithm, select a representative cluster including a largest number of devices from among the one or more clusters, and generate the at least one segment set including a segment matching the devices included in the representative cluster.

The at least one program may be configured to extract a common segment, included in all segment sets, from the at least one segment set, and isolate a security threat segment corresponding to the common segment, determined based on an inclusion relationship between segments and the common segment.

In accordance with another aspect of the present invention to accomplish the above objects, there is provided a dynamic segmentation method for preventing a spread of a security threat, the dynamic segmentation method being performed by a dynamic segmentation apparatus for preventing a spread of a security threat, the dynamic segmentation method including registering feature information of a first device, which is a target for which a security threat is to be managed, generating a first segment from the feature information of the first device, receiving security threat information from an external security detection system, and extracting feature information of a second device, in which a security threat has occurred, from the security threat information, performing clustering on the feature information of the second device using at least one preset clustering algorithm and generating at least one segment set by identifying segments from results of performing the clustering, and determining a security threat segment based on an inclusion relationship between segments included in the at least one segment set.

Generating the segment set may be configured to extract a feature factor to be used for clustering from the feature information of the second device and perform data preprocessing on the feature factor.

Generating the segment set may be configured to perform data preprocessing of converting a character string value of the feature factor into a numeric value.

Generating the segment set may be configured to generate one or more clusters using at least one preset clustering algorithm, select a representative cluster including a largest number of devices from among the one or more clusters, and generate the at least one segment set including a segment matching the devices included in the representative cluster.

Determining the security threat segment may be configured to extract a common segment, included in all segment sets, from the at least one segment set, and isolate a security threat segment corresponding to the common segment, determined based on an inclusion relationship between segments and the common segment.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a dynamic segmentation apparatus for preventing a spread of a security threat according to an embodiment of the present invention;

FIG. 2 is a diagram illustrating feature factors represented by character string values according to an embodiment of the present invention;

FIG. 3 is a diagram illustrating feature factors converted into numeric values according to an embodiment of the present invention;

FIG. 4 is a diagram illustrating a procedure for identifying segments from the results of clustering according to an embodiment of the present invention;

FIG. 5 is a diagram illustrating a procedure for extracting a common segment in clustering algorithms according to an embodiment of the present invention;

FIGS. 6 and 7 are diagrams illustrating a procedure for determining a security threat segment based on an inclusion relationship between segments according to an embodiment of the present invention;

FIG. 8 is an operation flowchart illustrating a dynamic segmentation method for preventing a spread of a security threat according to an embodiment of the present invention;

FIG. 9 is an operation flowchart illustrating in detail an example of the security threat information reception step illustrated in FIG. 8;

FIG. 10 is an operation flowchart illustrating in detail an example of the security threat analysis step illustrated in FIG. 8;

FIG. 11 is an operation flowchart illustrating in detail the security threat segment determination step illustrated in FIG. 8; and

FIG. 12 is a diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, preferred embodiments of the present invention will be described in detail with the attached drawings.

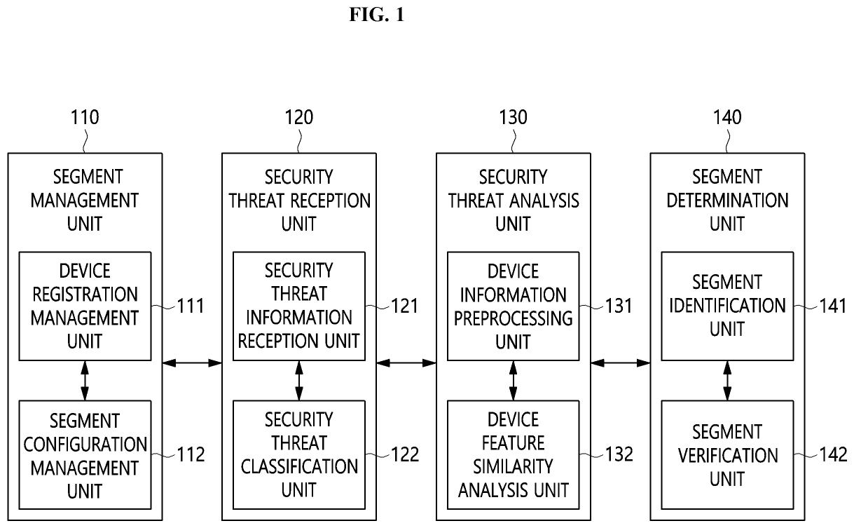

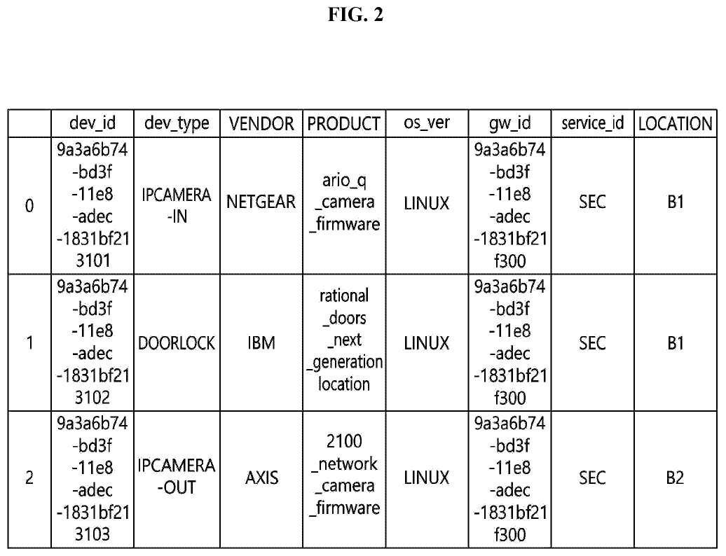

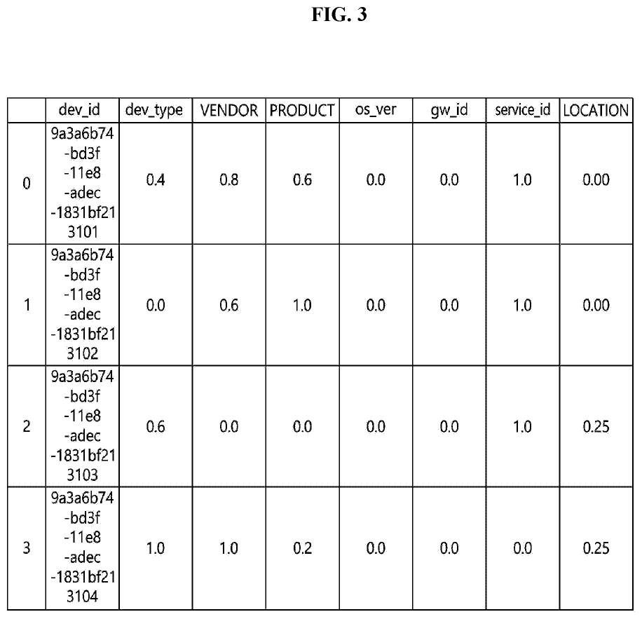

FIG. 1 is a block diagram illustrating a dynamic segmentation apparatus for preventing a spread of a security threat according to an embodiment of the present invention. FIG. 2 is a diagram illustrating feature factors represented by character string values according to an embodiment of the present invention. FIG. 3 is a diagram illustrating feature factors converted into numeric values according to an embodiment of the present invention.

Referring to FIG. 1, the dynamic segmentation apparatus for preventing a spread of a security threat according to the embodiment of the present invention includes a segment management unit 110, a security threat reception unit 120, a security threat analysis unit 130, and a segment determination unit 140.

The segment management unit 110 may include a device registration management unit 111 and a segment configuration management unit 112.

The device registration management unit 111 may register feature information of a first device, which is a target for which a security threat is to be managed.

Here, the device registration management unit 111 may register the feature information of each device through a manager or through an agent installed in the corresponding device.

The segment configuration management unit 112 may generate a first segment from the feature information of the first device.

Here, the segment configuration management unit 112 may collect the feature information of each device when the corresponding device is registered, wherein the segment may be generated from the feature information based on the type, the manufacturer, the product group, the firmware, the installation location, the user, etc. of the device.

The security threat reception unit 120 may include a security threat information reception unit 121 and a security threat classification unit 122.

The security threat information reception unit 121 may receive security threat information including information about a second device in which a security threat has occurred from an external security detection system.

The security threat classification unit 122 may normalize security threat information having various formats to be used for analysis into a common format by filtering the security threat information.

Here, the security threat classification unit 122 may identify whether an attack system and a damaged system related to the security threat are devices inside a management area, and if it is identified that both the attack system and the damaged system are devices outside the management area, may filter those devices.

Here, the security threat classification unit 122 may identify a security threat that occurs significantly more or spreads notably quickly and thus requires analysis and response, among security threats that have occurred during a preset analysis period.

Further, the security threat classification unit 122 may extract the feature information of the second device, in which the security threat has occurred, from the security threat information.

Here, the security threat classification unit 122 may extract the feature information of the second device from the security threat information based on the previously registered feature information of the first device.

The security threat analysis unit 130 may perform clustering on the feature information of the second device using at least one preset clustering algorithm, identify segments from the results of performing the clustering, and then generate at least one segment set.

The security threat analysis unit 130 may include a device information preprocessing unit 131 and a device feature similarity analysis unit 132.

The device information preprocessing unit 131 may extract feature factors to be used for clustering from the feature information of the second device, and may perform data preprocessing on the feature factors.

Here, the device information preprocessing unit 131 may perform data preprocessing of converting character string values of the feature factors into numeric values.

Referring to FIG. 2, the feature information of each device may include, as the feature factors of the corresponding device, information enabling the device to be identified, such as a device identifier, a host name, and an IP address, and the type, the use, the manufacturer, the product name, the firmware, the installation location, and the owner of the device. Here, the feature factors of the device may be represented by character string values.

Referring to FIG. 3, it can be seen that the device information preprocessing unit 131 converts the feature factors of the device into numeric values through data preprocessing.

The device feature similarity analysis unit 132 may perform clustering using one or more clustering algorithms so as to analyze similarities between devices.

Here, the device feature similarity analysis unit 132 may generate one or more clusters using at least one preset clustering algorithm, select a representative cluster including the largest number of devices from among the one or more clusters, and generate the at least one segment set including a segment matching the devices included in the representative cluster.

The clustering may be a procedure for grouping given entities into several clusters, and the entities in each cluster may have features similar to each other. Therefore, a clustering algorithm having the feature factors of the device as input values may output multiple clusters as result values, and the device feature similarity analysis unit 132 may determine that devices grouped into one cluster have similar features.

Here, the at least one preset clustering algorithm may include various types of clustering algorithms, classify pieces of data having similar features, among pieces of given data, and generate one group from the classified data.

The segment determination unit 140 may determine a security threat segment based on an inclusion relationship between the segments included in the common segments.

The segment determination unit 140 may include a segment identification unit 141 and a segment verification unit 142.

The segment identification unit 141 may extract a common segment included in all segment sets from the at least one segment set, thus identifying the common segment.

Here, when multiple clustering algorithms are performed and multiple segment sets are generated for each clustering algorithm, the segment identification unit 141 may extract a common segment from the segment sets generated as a result of performing each clustering algorithm.

The segment verification unit 142 may finally determine a segment to be isolated by comparatively verifying segments identified from the common segment.

Here, the segment verification unit 142 may isolate a security threat segment corresponding to the common segment, which is determined based on an inclusion relationship between the segments in the common segments.

FIG. 4 is a diagram illustrating a procedure for identifying segments from the results of clustering according to an embodiment of the present invention.

Referring to FIG. 4, it can be seen that a dynamic segmentation apparatus for preventing a spread of a security threat according to an embodiment of the present invention selects the cluster composed of the largest number of devices from among clusters generated by performing at least one clustering algorithm, and generates a segment set by detecting the segment to which the devices included in the cluster belong, among previously classified segments.

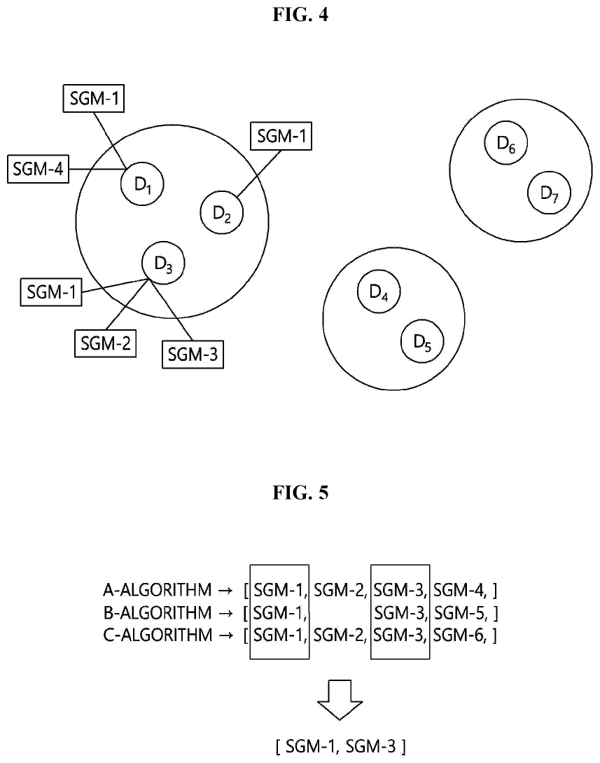

FIG. 5 is a diagram illustrating a procedure for extracting a common segment in clustering algorithms according to an embodiment of the present invention.

Referring to FIG. 5, it can be seen that the dynamic segmentation apparatus for preventing a spread of a security threat according to an embodiment of the present invention generates three segment sets by performing three clustering algorithms.

Here, it can be seen that all of the three segment sets include a segment SGM-1 and a segment SGM-3, and the dynamic segmentation apparatus for preventing a spread of a security threat according to the embodiment of the present invention determines the segment SGM-1 and the segment SGM-3 as common segments and then extract the segment SGM-1 and the segment SGM-3 as the common segments.

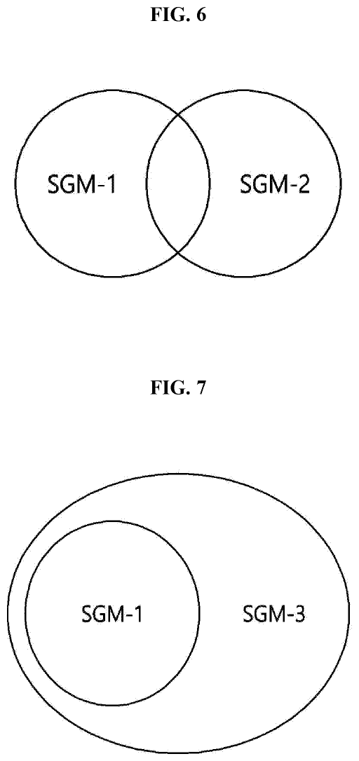

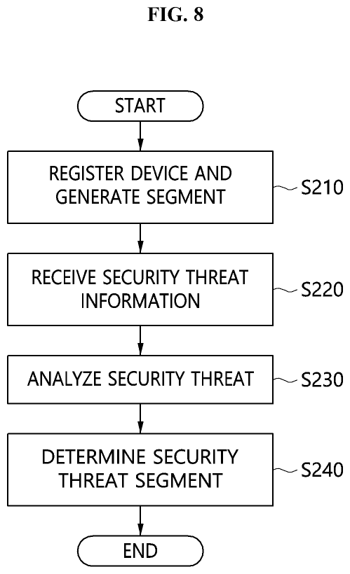

FIGS. 6 and 7 are diagrams illustrating a procedure for determining a security threat segment based on an inclusion relationship between segments according to an embodiment of the present invention.

Referring to FIG. 6, it can be seen that, when a segment SGM-1 is a security threat segment, only a part of a segment SGM-2 is included in the segment SGM-1 and that the dynamic segmentation apparatus for preventing a spread of a security threat according to an embodiment of the present invention determines both the segment SGM-1 and the segment SGM-2 to be isolation target segments in which a security threat may occur.

Referring to FIG. 7, it can be seen that a segment SGM-1 is included in a segment SGM-3 and that, when the segment SGM-1 is a security threat segment, the dynamic segmentation apparatus for preventing a spread of a security threat according to an embodiment of the present invention determines the segment SGM-3 to be an isolation target segment because the segment SGM-3 includes the segment SGM-1.

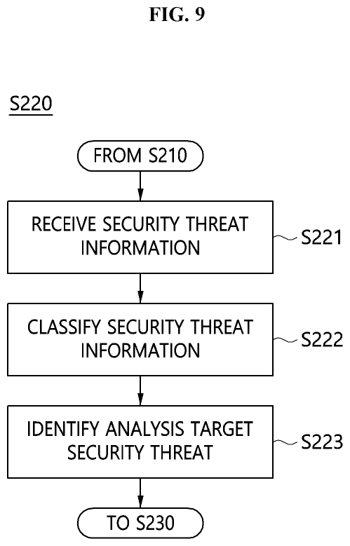

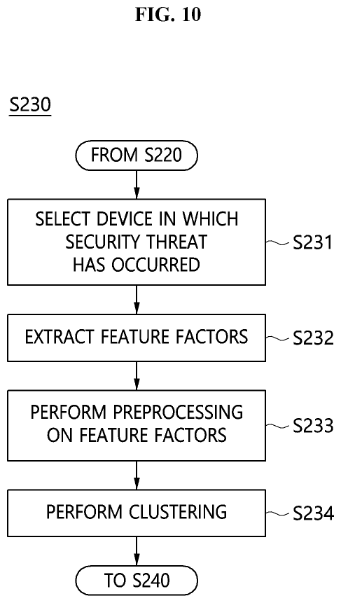

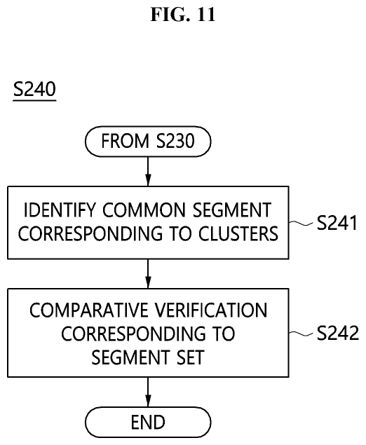

FIG. 8 is an operation flowchart illustrating a dynamic segmentation method for preventing a spread of a security threat according to an embodiment of the present invention. FIG. 9 is an operation flowchart illustrating in detail an example of the security threat information reception step illustrated in FIG. 8. FIG. 10 is an operation flowchart illustrating in detail an example of the security threat analysis step illustrated in FIG. 8. FIG. 11 is an operation flowchart illustrating in detail the security threat segment determination step illustrated in FIG. 8.

Referring to FIG. 8, the dynamic segmentation method for preventing a spread of a security threat according to the embodiment of the present invention may primarily register a device, and may generate a segment at step S210.

That is, at step S210, feature information of a first device, which is a target for which a security threat is to be managed, may be registered, and a first segment may be generated from the feature information of the first device.

At step S210, the feature information of the device may be registered through a manager or through an agent installed in the device.

At step S210, the first segment may be generated from the feature information of the first device.

At step S210, the feature information of the device may be collected when the device is registered, wherein the segment may be generated from the feature information based on the type, the manufacturer, the product group, the firmware, the installation location, the user, etc. of the device.

Further, the dynamic segmentation method for preventing a spread of a security threat according to the embodiment of the present invention may receive security threat information at step S220.

Referring to FIG. 9, at step S220, the security threat information including information about a second device in which a security threat has occurred may be received from an external security detection system at step S221.

Further, in the procedure at step S220, the security threat information may be classified at step S222.

That is, at step S222, security threat information having various formats to be used for analysis may be normalized (standardized) into a common format by filtering the security threat information.

Here, at step S222, whether an attack system and a damaged system related to a security threat are devices inside a management area may be identified. If it is identified that both the attack system and the damaged system are devices outside the management area, those devices may be filtered.

Furthermore, in the procedure at step S220, a security threat that is an analysis target may be identified, and feature information of a second device, in which a security threat has occurred, may be extracted from the security threat information at step S223.

At step S223, a security threat that occurs significantly more or spreads notably quickly and thus requires analysis and response may be identified, among security threats that have occurred during a preset analysis period.

Here, at step S223, the feature information of the second device may be extracted from the security threat information based on the previously registered feature information of the first device.

Furthermore, the dynamic segmentation method for preventing a spread of a security threat according to the embodiment of the present invention may analyze the security threat at step S230.

At step S230, clustering may be performed on the feature information of the second device using at least one preset clustering algorithm, segments may be identified from the results of performing the clustering, and then at least one segment set may be generated.

Referring to FIG. 10, in the procedure at step S230, a device in which a security threat has occurred may be selected at step S231.

Further, in the procedure at step 230, feature factors may be extracted from the device in which the security threat has occurred at step S232.

Also, in the procedure at step S230, data preprocessing may be performed on the feature factors at step S233.

That is, at step S233, feature factors to be used for clustering may be extracted from the feature information of the second device, and data preprocessing may be performed on the feature factors.

In this case, at step S233, data preprocessing of converting character string values of the feature factors into numeric values may be performed.

Referring to FIG. 2, the feature information of each device may include, as the feature factors of the corresponding device, information enabling the device to be identified, such as a device identifier, a host name, and an IP address, and the type, the use, the manufacturer, the product name, the firmware, the installation location, and the owner of the device.

Referring to FIG. 3, at step S233, it can be seen that the feature factors of the device are converted into numeric values through data preprocessing.

Further, in the procedure at step S230, clustering may be performed using one or more clustering algorithms so as to analyze similarities between devices at step S234.

That is, at step S234, the preprocessed feature factors of the device may be clustered using at least one preset clustering algorithm.

Here, at step S234, one or more clusters may be generated using the at least one preset clustering algorithm, a representative cluster including the greatest number of devices may be selected from among the one or more clusters, and the at least one segment set including a segment matching the devices included in the representative cluster may be generated.

Such clustering may be a procedure for grouping given entities into several clusters, and the entities in each cluster may have features similar to each other. Therefore, the clustering algorithm having the feature factors of the device as input values may output multiple clusters as result values. In this case, at step S234, it may be determined that the devices grouped into one cluster have similar features.

Further, the dynamic segmentation method for preventing a spread of a security threat according to the embodiment of the present invention may determine a security threat segment at step S240.

That is, at step S240, the security threat segment may be determined based on an inclusion relationship between the segments included in the at least one segment set.

Referring to FIG. 11, in the procedure at step S240, a common segment included in all segment sets may be identified at step S241.

That is, at step S241, the common segment included in all segment sets may be extracted and identified from the at least one segment set.

Here, at step S241, when multiple clustering algorithms are performed and multiple segment sets are generated for each clustering algorithm, the common segment may be extracted from the segment sets generated as a result of performing each clustering algorithm.

Furthermore, in the procedure at step S240, the comparative verification corresponding to the segment set may be performed at step S242.

That is, at step 242, a segment to be isolated may be finally determined by comparatively verifying the segments identified from the common segment.

Here, at step S242, a security threat segment corresponding to the common segment, which is determined based on the inclusion relationship between the segments in the common segments, may be isolated.

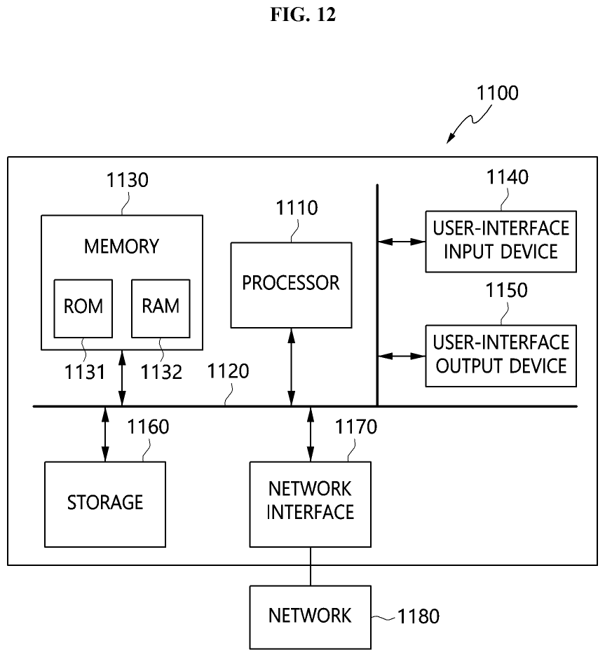

FIG. 12 is a diagram illustrating a computer system according to an embodiment of the present invention.

Referring to FIG. 12, a dynamic segmentation apparatus for preventing a spread of a security threat according to an embodiment of the present invention may be implemented in a computer system 1100, such as a computer-readable storage medium. As illustrated in FIG. 12, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

The dynamic segmentation apparatus for preventing a spread of a security threat according to an embodiment of the present invention may include one or more processors 1100 and execution memory 1130 for storing at least one program that is executed by the one or more processors 1110, wherein the at least one program may be configured to register feature information of a first device, which is a target for which a security threat is to be managed, generate a first segment from the feature information of the first device, receive security threat information from an external security detection system, extract feature information of a second device, in which a security threat has occurred, from the security threat information, perform clustering on the feature information of the second device using at least one preset clustering algorithm, generate at least one segment set by identifying segments from the results of performing the clustering, and determine a security threat segment based on an inclusion relationship between the segments included in the at least one segment set.

The at least one program may be configured to extract a feature factor to be used for clustering from the feature information of the second device and perform data preprocessing on the feature factor.

The at least one program may be configured to perform data preprocessing of converting a character string value of the feature factor into a numeric value.

The at least one program may be configured to generate one or more clusters using at least one preset clustering algorithm, select a representative cluster including the largest number of devices from among the one or more clusters, and generate the at least one segment set including a segment matching the devices included in the representative cluster.

The at least one program may be configured to extract a common segment, included in all segment sets, from the at least one segment set, and isolate a security threat segment corresponding to the common segment, determined based on an inclusion relationship between the segments in the common segments.

In accordance with an embodiment of the present invention, an attacker infects IoT devices with malicious code by taking advantage of vulnerabilities of the IoT devices in order to use the IoT devices as zombie devices in a botnet. Since devices having similar features have the same security vulnerabilities due to those features, there is a strong possibility that a security threat will propagate to other devices having features similar to those of the device in which the security threat has occurred. Therefore, the dynamic segmentation apparatus and method for preventing a spread of a security threat according to the embodiment of the present invention may prevent malicious code from spreading throughout the entire IoT infrastructure by segmenting devices having features similar to those of the device in which a security threat has occurred.

The present invention may prevent a security threat penetrating an IoT infrastructure from spreading throughout the entire IoT infrastructure.

Further, the present invention may minimize the spread of a security threat by identifying a device having a strong possibility of occurrence of a security threat and isolating the corresponding device.

As described above, in the dynamic segmentation apparatus and method for preventing a spread of a security threat according to the present invention, the configurations and schemes in the above-described embodiments are not limitedly applied, and some or all of the above embodiments can be selectively combined and configured such that various modifications are possible.

What is claimed is:

1. A dynamic segmentation apparatus for preventing a spread of a security threat, comprising:
one or more processors; and
an execution memory for storing at least one program that is executed by the one or more processors,
wherein the at least one program is configured to:
register feature information of a first device, which is a target for which a security threat is to be managed, generate a first segment from the feature information of the first device, receive security threat information from an external security detection system, and extract feature information of a second device, in which a security threat has occurred, from the security threat information,
perform clustering on the feature information of the second device using at least one preset clustering algorithm and generate at least one segment set by identifying segments from results of performing the clustering, and
determine a security threat segment based on an inclusion relationship between segments included in the at least one segment set.

2. The dynamic segmentation apparatus of claim 1, wherein the at least one program is configured to extract a feature factor to be used for clustering from the feature information of the second device and perform data preprocessing on the feature factor.

3. The dynamic segmentation apparatus of claim 2, wherein the at least one program is configured to perform data preprocessing of converting a character string value of the feature factor into a numeric value.

4. The dynamic segmentation apparatus of claim 2, wherein the at least one program is configured to generate one or more clusters using at least one preset clustering algorithm, select a representative cluster including a largest number of devices from among the one or more clusters, and generate the at least one segment set including a segment matching the devices included in the representative cluster.

5. The dynamic segmentation apparatus of claim 4, wherein the at least one program is configured to extract a common segment, included in all segment sets, from the at least one segment set, and isolate a security threat segment corresponding to the common segment, determined based on an inclusion relationship between segments corresponding to the common segment.

6. A dynamic segmentation method for preventing a spread of a security threat, the dynamic segmentation method being performed by a dynamic segmentation apparatus for preventing the spread of the security threat, the dynamic segmentation method comprising:
registering feature information of a first device, which is a target for which a security threat is to be managed, generating a first segment from the feature information of the first device, receiving security threat information from an external security detection system, and extracting feature information of a second device, in which a security threat has occurred, from the security threat information;
performing clustering on the feature information of the second device using at least one preset clustering algorithm and generating at least one segment set by identifying segments from results of performing the clustering; and
determining a security threat segment based on an inclusion relationship between segments included in the at least one segment set.

7. The dynamic segmentation method of claim 6, wherein generating the segment set is configured to extract a feature factor to be used for clustering from the feature information of the second device and perform data preprocessing on the feature factor.

8. The dynamic segmentation method of claim 7, wherein generating the segment set is configured to perform data preprocessing of converting a character string value of the feature factor into a numeric value.

9. The dynamic segmentation method of claim 7, wherein generating the segment set is configured to generate one or more clusters using at least one preset clustering algorithm, select a representative cluster including a largest number of devices from among the one or more clusters, and generate the at least one segment set including a segment matching the devices included in the representative cluster.

10. The dynamic segmentation method of claim 9, wherein determining the security threat segment is configured to extract a common segment, included in all segment sets, from the at least one segment set, and isolate a security threat segment corresponding to the common segment, determined based on an inclusion relationship between segments corresponding to the common segment.
